(19) United States
(12) Patent Application Publication
(10) Pub. No.: US 2005/0185302 A1
(43) Pub. Date: Aug. 25, 2005

(54) [LIGHT SOURCE ADJUSTING MODULE]

(76) Inventor: Chih-Hao Chang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/710,043

(22) Filed: Jun. 15, 2004

(30) Foreign Application Priority Data
Feb. 20, 2004 (TW) 93104200

(51) Int. Cl. G02B 7/02

(52) U.S. Cl. 359/819

(57) ABSTRACT

A light source adjusting module for processing a beam of light projected from a light source. The light source adjusting module comprises a sleeve, a first optical element, a first holder for carrying the first optical element, a second optical element, a second holder for carrying the second optical element, a first adjusting member, a second adjusting member and a sleeve-adjusting member. The position of the first optical element can be adjusted through the first adjusting member and the position of the second optical element can be adjusted through the second adjusting member. Furthermore, the angle of the rotatable sleeve can be set through the sleeve-adjusting member. A beam projected from a light source can be adjusted to meet a specific design requirement after appropriately setting the adjustable members within the light source adjusting module.

### CROSS REFERENCE TO RELATED APPLICATIONS

This application claims the priority benefit of Taiwan application serial no. 93104200, filed Feb. 20, 2004.

### BACKGROUND OF INVENTION

1. Field of the Invention

The present invention relates to a light source module. More particularly, the present invention relates to a light source adjusting module.

2. Description of the Related Art

In recent years, liquid crystal displays have been widely adopted in many electrical appliances including televisions, portable computers and projectors. In general, the optical system inside a liquid crystal projector may be an off-axial design or an on-axial design. The incident light and the output light source in an off-axial optical system are on different planes. On the other hand, the incident light source and the output light source in an on-axial optical system are on the same plane. Furthermore, according to the type of projection, a liquid crystal projector can be divided into the front-projecting type and the rear-projecting type. At present, most liquid crystal projectors adopt rear-projecting and on-axial design. In the design and fabrication of liquid crystal projector, the main concerns are the projection quality as well as the size and weight of the optical system within the projector.

The light source module of most projectors has a light source that provides a light beam through a rod integrator before traveling to the lens so that the lens can focus to produce an image on a designated location. However, without any adjusting mechanism within the light source module, the projector cannot provide suitable focusing adjustment or projecting area adjustments when the projector is placed in a different environment. In other words, a clear projection is only obtained if we apply certain restrictions to the servicing environment. Hence, the provision of some adjusting mechanisms inside the light source module of the projector is sure to increase the clarity of images and relax some of the environmental restrictions.

Adjustable lens modules have been widely adopted in many types of optical products including cameras and lens systems. For example, U.S. Pat. No. 3,951,522 disclosed a movable camera lens module. The adjustable camera lens module comprises a holder for carrying a lens. Furthermore, a pair of sleeves is disposed on the exterior surface of the holder so that the outer sleeve may rotate. Through a guiding pin on the holder and a guiding groove on the pair of sleeves, the lens is free to move along the main optical axis and change the focusing point of light so that the focal point of the camera lens can be set accordingly.

Although the aforementioned adjusting mechanism has been used in cameras, none has been applied to a projector so far. Furthermore, with the miniaturization of projectors, the amount of movement permitted by the lens in the light source module is severely restricted. Thus, even if the aforementioned disclosed patent is applied to a projector, moving the lens alone may still not provide the sufficient window of adjustment needed to refocus an incident light beam or change the size of projection area.

### SUMMARY OF INVENTION

Accordingly, the present invention is directed to a light source adjusting module capable of adjusting the distance between an incident light beam and lenses for forming an image.

The present invention is also directed to a light source adjusting module capable of adjusting the position of lenses to change the focus point of a light beam.

The present invention is also directed to a light source adjusting module capable of rotating a projected image.

According to an embodiment of the present invention, the light source adjusting module is provided. The light source adjusting module comprises a sleeve having first and second grooves on its surface, a first optical element disposed inside the sleeve having an incident surface and an output surface, a second optical element disposed on an optical path of the light beam behind the first optical element, a first adjusting member contacted to the first optical element through said first groove of the sleeve, a second holder disposed inside the sleeve for carrying the second optical element and a second adjusting member mounted to the second holder through second groove of the sleeve so that the second holder and the second optical element can be moved relative to the sleeve by moving the second adjusting member. Wherein a light beam enters the first optical element through the incident surface and emerges from the output surface of the first optical element. Moreover, the first optical element can be moved relative to the sleeve by moving the first adjusting member.

According to an embodiment of the present invention, the second holder can be moved horizontally inside the sleeve by moving the second adjusting member within the second groove, and the second holder comprises a cylinder disposed and overlapped to later part of the first holder.

According to an embodiment of the present invention, the light source adjusting module further comprises a first holder disposed inside the sleeve for carrying the first optical element and a first adjusting member mounted to the first holder through said first groove of the sleeve. Wherein the first holder and the first optical element can be moved relative to the sleeve by moving the first adjusting member.

According to an embodiment of the present invention, the light source adjusting module further comprises a reflecting plate disposed at one end of the first holder over the incident surface of the first optical element, and the reflecting plate has an opening that exposes at least a portion of the incident surface of the first optical element so that any interfering background light is filtered off.

According to an embodiment of the present invention, the first holder can be moved horizontally inside the sleeve by moving the first adjusting member within the first groove.

According to an embodiment of the present invention, the first holder can be rotated relative to the sleeve by moving the first adjusting member within the first groove.

According to an embodiment of the present invention, the module further comprises a sleeve-adjusting member mounted to the sleeve through third groove so that the sleeve can be moveable relative to the first sleeve ring.

According to an embodiment of the present invention, the module further comprises an elastic element disposed over the outer surface of the first holder and a second sleeve ring disposed over the first holder and the elastic element mounted to the sleeve. The second sleeve ring to stop the elastic element from forcing the first holder away from the sleeve.

According to an embodiment of the present invention, the first optical element may be a rod integrator, and the second optical element is, for example, at least one lens.

According to an embodiment of the present invention, a second type of light source adjusting module for processing a light beam from a light source is provided. The light source adjusting module comprises a sleeve having a first and second grooves on its surface, a first optical element disposed inside the sleeve having an incident surface and an output surface, a second optical element disposed along an optical path of the light beam behind the second optical element, a second holder disposed inside the sleeve for carrying the second optical element and a second adjusting member mounted to the second holder through the second groove. Wherein a light beam enters the first optical element through the incident surface and emerges from the output surface of the first optical element. Moreover, the second holder and the second optical element can be moved relative to the sleeve by moving the second adjusting member.

According to an embodiment of the present invention, the second holder can be moved horizontally inside the sleeve by moving the second adjusting member within the second groove.

According to an embodiment of the present invention, the second holder can be rotated relative to the sleeve by moving the second adjusting member within the second groove.

According to an embodiment of the present invention, the second holder comprises a cylinder disposed and overlapped to later part of the first holder.

According to an embodiment of the present invention, the module further comprises a reflecting plate disposed along the optical path of a light beam entering the first optical element, and the reflecting plate has an opening that exposes at least a portion of the incident surface of the first optical element so that only the light passing through the opening enters the first optical element.

According to an embodiment of the present invention, the module further comprises a sleeve-adjusting member contacted to the sleeve for directly rotating the sleeve. Wherein the module further comprises a first sleeve ring disposed over the sleeve and the first sleeve ring has a third groove such that the sleeve can be rotated by moving the sleeve-adjusting member within the third groove.

According to an embodiment of the present invention, the first optical element comprises a rod integrator.

According to an embodiment of the present invention, the second optical element comprises at least one lens.

According to an embodiment of the present invention, a third type of light source adjusting module for processing a light beam from a light source is provided. The light source adjusting module comprises a sleeve, a first optical element disposed inside the sleeve having an incident surface and an output surface, a second optical element disposed on an optical path of the light beam behind the first optical element, a first sleeve ring disposed over the sleeve g having a third groove and a sleeve-adjusting member contacted to the sleeve through the third groove. Wherein a light beam enters the first optical element through the incident surface and emerges from the output surface of the first optical element. Moreover, the sleeve can be moved relative to the first and second optical element by moving the sleeve-adjusting member within the third groove.

According to an embodiment of the present invention, the module further comprises a reflecting plate disposed along the optical path of a light beam entering the first optical element, and the reflecting plate has an opening that exposes at least a portion of the incident surface of the first optical element so that only the light passing through the opening enters the first optical element.

According to an embodiment of the present invention, the surface of the sleeve having a first groove and the module further comprises a first holder disposed inside the sleeve for carrying the first optical element and a first adjusting member disposed on the sleeve. Wherein the adjusting member passes through the first groove and connects to the first holder so that the first holder can be moved relative to the sleeve by moving the first adjusting member within the first groove.

According to an embodiment of the present invention, the first holder can be moved horizontally inside the sleeve by moving the first adjusting member within the first groove.

According to an embodiment of the present invention, the first holder can be rotated relative to the sleeve by moving the first adjusting member within the first groove.

According to an embodiment of the present invention, the module further comprises an elastic element disposed within the axial gap on the outer surface of the first holder and a second sleeve ring disposed over the first holder and contacted to the sleeve. The second sleeve ring is used to stop the elastic element from forcing the first holder away from the sleeve.

According to an embodiment of the present invention, the first optical element may be a rod integrator, and the second optical element is, for example, at least one lens.

According to an embodiment of the present invention, a fourth type of light source adjusting module for processing a light beam from a light source is provided. The light source adjusting module comprises a sleeve having a first and second grooves on its surface, a first optical element having an incident surface and an output surface, a second optical element disposed on an optical path of the light beam behind the first optical element, a first adjusting member contacted to the first optical element through said first groove of the sleeve, a second holder disposed inside the sleeve for carrying the second optical element, a second adjusting member mounted to the second holder through second groove of the sleeve and a sleeve-adjusting member contacted to the sleeve for directly moving the sleeve. Wherein a light beam enters the first optical element through the incident surface and emerges from the output surface of the first optical element. Furthermore, the first optical element is moved relative to the sleeve by moving the first adjusting member, and the second holder and the second optical element are moved relative to the sleeve by moving the second adjusting member.

In brief, the present invention utilizes a change in position of the rod integrator and the lens to adjust the clarity of image projection. Furthermore, the angle of an image can be changed through various adjusting members within the adjusting module as well. Hence, the light source adjusting module is able to optimize the brightness and uniformity of a projected image through an adjustment of the adjusting members.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a perspective view of a light source adjusting module according to one embodiment of the present invention.

FIG. 1B is an exploded view of the light source adjusting module shown in FIG. 1A.

FIG. 2 is a top view showing a portion of the light source adjusting module in FIG. 1A.

FIG. 3 is a cross-sectional view taken along line I-I′ in FIG. 2.

FIG. 4 is a cross-sectional view taken along line II-II′ in FIG. 2.

FIG. 5 is a cross-sectional view taken along line III-III′ in FIG. 2.

FIG. 6 is a cross-sectional view taken along line IV-IV′ in FIG. 2.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

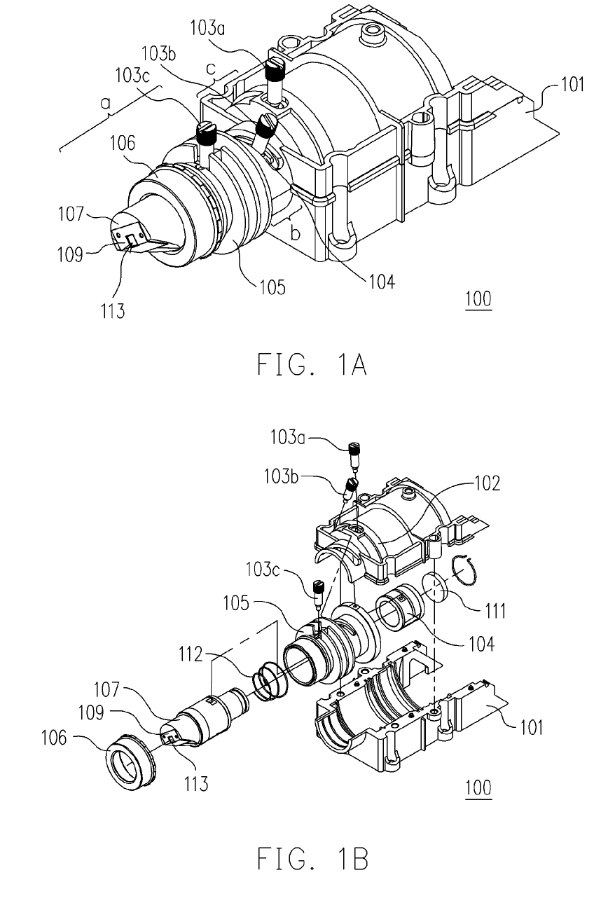

FIG. 1A is a perspective view of a light source adjusting module according to one embodiment of the present invention. FIG. 1B is an exploded view of the light source adjusting module shown in FIG. 1A. As shown in FIGS. 1A and 1B, the light source adjusting module 100 mainly comprises a sleeve 105, a first optical element 110, a second optical element 111, a first holder 107, a second holder 104, a sleeve-adjusting member 103a, a second adjusting member 103b and a first adjusting member 103c. The sleeve 105 is disposed on a base 101. In the present embodiment, the light source adjusting module 100 includes a first adjusting mechanism “a”, a second adjusting mechanism “b” and a third adjusting mechanism “c”. The first adjusting mechanism “a” comprises the first holder 107 and the first adjusting member 103c. The second adjusting mechanism “b” comprises the second holder 104 and the second adjusting member 103b. The third adjusting mechanism “c” comprises the sleeve-adjusting member 103a. In the following, a detailed account of the first, second and third adjusting mechanisms inside the light source adjusting module 100 are described.

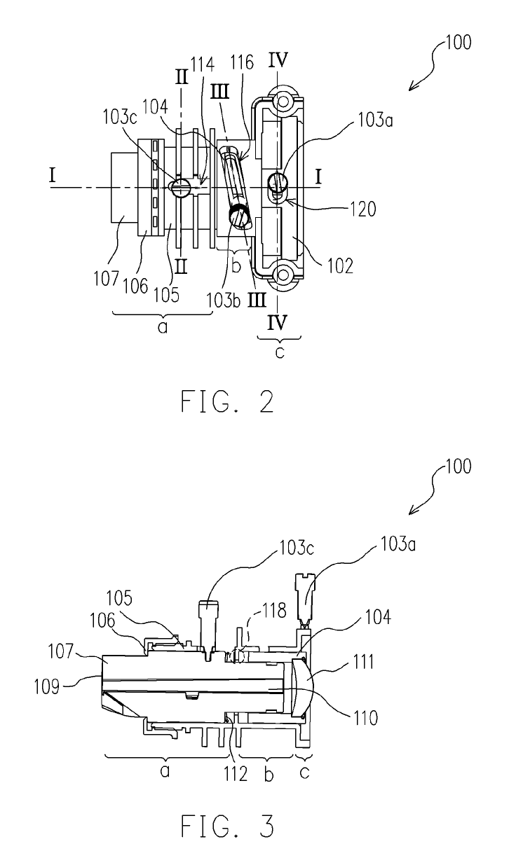

FIG. 2 is a top view showing a portion of the light source adjusting module in FIG. 1A. FIG. 3 is a cross-sectional view taken along line I-I′ in FIG. 2. As shown in FIGS. 1A, 2 and 3, the first optical element 110 is a rod integrator with an incident surface and an output surface for light, for example. Hence, a beam from a light source (not shown) projects onto the incident surface of the first optical element 110 and outputs from the output surface after collimation. The first holder 107 supports the first optical element 110 inside the sleeve 105. In this embodiment, the first holder 107 is a cylinder that is disposed into the sleeve 105, for example. The first optical element 110 is disposed into the interior of the cylindrical first holder 107, for example.

Although the first optical element 110 is a rod integrator in this embodiment, the first optical element 110 can be some other optical devices including at least one lens. In addition, there is no particular restriction on the design of the first holder 107. Accordingly, the first holder 107 can be designed to correspond with the type of optical element 110 selected. The first holder 107 is, for example, a semicircular carrier (not shown) for fastening a cylindrical optical element onto a concave semicircular surface.

The second optical element 111 is a lens, for example. The second holder 104 supports the second optical element 111 inside the sleeve 105. The second holder 104 is a cylinder that is disposed into the interior of the sleeve 105, for example. Furthermore, the second optical element 111 is disposed somewhere along the optical path of the light beam behind the first optical element 110. For example, the second optical element 111 is disposed in front of the output surface of the first optical element 110. One side of the second optical element 111 is exposed at one end of the sleeve 105 to prevent the interior wall of the sleeve 105 from diffusing the light emerging from the second optical element 111 leading to the projection of a diffused image.

Obviously, there is no particular restriction on the design of the second holder 104. The second holder 104 can be some other type of carrier including, for example, a circular holder (not shown). In general, the second optical element 111 is fastened to opening in the middle of the second holder.

In addition, a reflecting plate may also be installed inside the light source adjusting module 100 along the optical path of a light beam before the light beam enters the first optical element 110 through the incident surface. As shown in FIGS. 1A, 1B and 3, the reflecting plate 109 is disposed at one end of the first holder 107. The reflecting plate 109 has a rectangular opening 113 that exposes a portion of the incident surface of the first optical element 110. Hence, light from a light source is able to get into the adjusting module 100 only through the opening 113 so that any interfering background light is filtered off.

FIG. 4 is a cross-sectional view along line II-II′ in FIG. 2. As shown in FIGS. 2, 3 and 4, the surface of the sleeve 105 has a groove 114. The first adjusting member 103c passes through the groove 114 and connects to the first holder 107. The means of locking the first adjusting member 103c to the first holder 107 includes a screw, for example. The groove 114 is oriented in a direction parallel to the axis of the sleeve 105 so that the first holder 107 is moved inside the sleeve 105 along an axial direction horizontally by moving the first adjusting member 103c inside the groove 114. Hence, the distance between the first optical element 110 and the second optical element 111 can be adjusted to enhance the brightness and size of a projected image. After moving the first optical element 110 to a suitable position, the first adjusting member 103c is screwed so that the position of the first holder 107 between the sleeve 105 is fixed. Furthermore, the surface of the sleeve 105 has a plurality of graduation marks on the edges around the groove 114. The graduation marks serve as a guide to users in finding out how far the first optical element 110 has moved.

However, there is no particular limitation in the way the groove 114 is set on the sleeve 105. Aside from the aforementioned setup, the groove 114 may follow a surface arc of the sleeve 105 so that the first holder 107 is able to move forward axially inside the sleeve 105 and rotate relative to the sleeve 105 at the same time. In this way, the position of the first holder 107 can be finely adjusted.

It should be noted that although the light source adjusting module has a first adjusting mechanism “a”, a second adjusting mechanism “b” and a third adjusting mechanism “c”, each adjusting mechanism can be independently operated. Hence, in another preferred embodiment, the adjusting mechanism “a” can be used alone in the light source adjusting module (not shown) of the present invention.

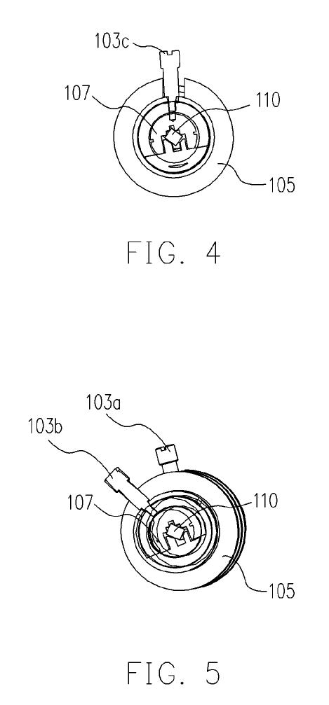

FIG. 5 is a cross-sectional view along line III-III′ in FIG. 2. As shown in FIGS. 2 and 5, the surface of the sleeve 105 also has another groove 116. The second adjusting member 103b passes through the groove 116 and connects to the second holder 104. The second adjusting member 103b is locked onto the second holder 104 by means of a screw and a threaded-hole assembly, for example. The groove 116 is disposed along a surface arc of the sleeve 105 so that the second holder 104 is moved along the axial direction inside the sleeve 105 and is rotated relative to the sleeve 105 at the same time by moving the second adjusting member 103b inside the groove 116. Hence, the position of the second optical element 111 can be adjusted. In this embodiment, the second optical element 111 is a lens, for example. Therefore, adjusting the position of the second optical element 111 will change the focusing point of a light beam passing out from the second optical element 111 and produce a clearer image.

After moving the second optical element 111 to a suitable location, the second adjusting member 103b is screwed so that the position of the second holder 104 between the sleeve 105 is fixed. Furthermore, the surface of the sleeve 105 has a plurality of graduation marks on the edges around the groove 116. The graduation marks serve as a guide to users in finding out how far the second optical element 111 has moved.

Obviously, the groove 116 can also be oriented in a direction parallel to the axis of the sleeve 105 so that the second holder 104 can move horizontally in an axial direction inside the sleeve 105.

It should be noted that although the light source adjusting module has a first adjusting mechanism “a”, a second adjusting mechanism “b” and a third adjusting mechanism “c”, each adjusting mechanism can be independently operated. Hence, in another preferred embodiment, the adjusting mechanism “b” can be used alone in the light source adjusting module (not shown) of the present invention or used together with the adjusting mechanism “a” in the light source adjusting module (not shown).

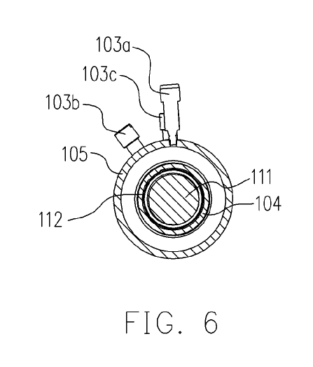

FIG. 6 is a cross-sectional view along line IV-IV′ in FIG. 2. As shown in FIGS. 3 and 6, the sleeve-adjusting member 103a is contacted to the sleeve 105 for directly rotating the sleeve 105. The sleeve-adjusting member 103a is contacted to the sleeve 105 by means of a screw and threaded-hole assembly, for example. Since rotating the sleeve 105 will also rotate the first holder 107 and the second holder 104 synchronously, the angle of rotation of the opening 113 on the reflecting plate 109 at one end of the first holder 107 can be changed. Through a changing in the rotation angle of the opening 113, the orientation of a projected image can be adjusted. For example, if a projected image after setting the first optical element 110 and the second optical element 111 to the most suitable positions differs from the vertical position by a counterclockwise tilt of 10°, rotating the sleeve-adjusting member 103a clockwise by 10° can correct the tilt.

In addition, the angle of rotation of the sleeve 105 can be limited to perform a fine adjustment of the projected image.

Furthermore, as shown in FIGS. 1B and 2, the light source adjusting module 100 may further include a sleeve ring 102 on the sleeve 105. The sleeve ring 102 has a groove 120, for example. The sleeve-adjusting member 103a passes through the groove 120 and connects to the sleeve 105. The groove 120 is disposed along a tangent direction of the sleeve ring 102 so that the sleeve 105 is rotated by moving the sleeve-adjusting member 103a along the groove 120. The surface of the sleeve ring 102 has a plurality of graduation marks on the edges around the groove 120. The graduation marks serve as a guide to users in finding out the angle through which the sleeve 105 has rotated.

It should be noted that although the light source adjusting module has a first adjusting mechanism “a”, a second adjusting mechanism “b” and a third adjusting mechanism “c”, each adjusting mechanism can be independently operated. Hence, in another preferred embodiment, the adjusting mechanism “c” can be used alone in the light source adjusting module (not shown) of the present invention. Alternatively, the adjusting mechanism “c” can be used together with the adjusting mechanism “a” or the adjusting mechanism “b” in the light source adjusting module (not shown). However, putting all the adjusting mechanisms “a”, “b” and “c” together in the same light source adjusting module is the one shown in the figures according to the embodiment of the present invention.

As shown in FIG. 3, the first holder 107 is a cylinder with a variable radius. The first holder 107 has a larger radius in the central portion than each end, for example. Furthermore, the interior of the sleeve 105 has a ring-like protruding member 118. There is an axial gap between the first holder 107 and the ring-like protruding member 118 so that some movement of the first holder 107 in the axial direction inside the sleeve 105 is permitted. Similarly, there is an axial gap between the second holder 104 and the ring-like protruding member 118 so that some movement of the second holder 104 in the axial direction within the sleeve 105 is permitted.

To buffer the axial movement of the first holder 107 inside the sleeve 105 so that any damage or shift in position of internal elements caused by a sudden impact of the first holder 107 on the ring-like protruding member 118 of the sleeve 105 is prevented, an elastic element 112 is disposed within the axial gap between the first holder 107 and the ring-like protruding member 118. The elastic element 112 is a circular spring plate disposed into the first holder 107, for example.

An additional sleeve ring 106 is also mounted over the exposed first holder 107 at one end of the sleeve 105. The sleeve ring 106 is contacted to the sleeve 105 and has a smallest radius smaller than the central portion of the first holder 107. Here, the variable radius of the first holder 107 is utilized to grip the sleeve ring 106 tightly and prevent the elastic element 112 from forcing the first holder 107 away from the sleeve 105.

In summary, the present invention utilizes the change in distance between the two optical elements such as the rod integrator and the lens inside a light source adjusting module to adjust the size and brightness of a projected image and prevent chromatic aberration of images due to external vibrations. In addition, the focusing point can be changed through an adjustment of the lens so that a clearer projected image is obtained. Furthermore, the entire light source adjusting module can be rotated to correct any tilt in the projected image. Therefore, a projected image with the optimal brightness and uniformity is obtained when the light source adjusting module of the present invention is used inside a projector.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A light source adjusting module, for guiding a light beam from a light source, comprising:
a sleeve having first and second grooves on its surface;
a first optical element disposed inside the sleeve having an incident surface and an output surface, wherein a light beam enters the first optical element through the incident surface and emerges from the output surface of the first optical element;
a second optical element disposed on an optical path of the light beam behind the first optical element;
a first adjusting member contacted to the first optical element through said first groove of the sleeve so that the first optical element can be moved relative to the sleeve by moving the first adjusting member;
a second holder disposed inside the sleeve for carrying the second optical element; and
a second adjusting member mounted to the second holder through second groove of the sleeve so that the second holder and the second optical element can be moved relative to the sleeve by moving the second adjusting member.

2. The light source adjusting module of claim 1, wherein the second holder can be moved horizontally inside the sleeve by moving the second adjusting member within the second groove.

3. The light source adjusting module of claim 1, wherein the second holder comprises a cylinder disposed and overlapped to later part of the first holder.

4. The light source adjusting module of claim 1, wherein further comprises:
a first holder disposed inside the sleeve for carrying the first optical element; and
a first adjusting member mounted to the first holder through said first groove of the sleeve so that the first holder and the first optical element can be moved relative to the sleeve by moving the first adjusting member.

5. The light source adjusting module of claim 1, wherein the module further comprises a sleeve-adjusting member mounted to the sleeve through third groove so that the sleeve can be moveable relative to the first sleeve ring.

6. The light source adjusting module of claim 1, wherein the module further comprises:
an elastic element disposed over the outer surface of the first holder; and
a second sleeve ring disposed over the first holder and the elastic element mounted to the sleeve for stopping the elastic element from forcing the first holder away from the sleeve.

7. The light source adjusting module of claim 1, wherein the first optical element comprises a rod integrator.

8. The light source adjusting module of claim 1, wherein the second optical element comprises at least one lens.

9. The light source adjusting module of claim 4, further comprising a reflecting plate disposed at one end of the first holder over the incident surface of the first optical element, and the reflecting plate has an opening that exposes at least a portion of the incident surface of the first optical element so that any interfering background light is filtered off.

10. The light source adjusting module of claim 4, wherein the first holder can be moved horizontally inside the sleeve by moving the first adjusting member within the first groove.

11. The light source adjusting module of claim 4, wherein the first holder can be rotated relative to the sleeve by moving the first adjusting member within the first groove.

12. A light source adjusting module, for processing a light beam from a light source, comprising:
a sleeve having a first and second grooves on its surface;
a first optical element disposed inside the sleeve having an incident surface and an output surface, wherein a light beam enters the first optical element through the incident surface and emerges from the output surface of the first optical element;
a second optical element disposed along an optical path of the light beam behind the second optical element;
a second holder disposed inside the sleeve for carrying the second optical element; and
a second adjusting member mounted to the second holder through the second groove so that the second holder and the second optical element can be moved relative to the sleeve by moving the second adjusting member.

13. The light source adjusting module of claim 12, wherein the second holder can be moved horizontally inside the sleeve by moving the second adjusting member within the second groove.

14. The light source adjusting module of claim 12, wherein the second holder can be rotated relative to the sleeve by moving the second adjusting member within the second groove.

15. The light source adjusting module of claim 12, wherein the second holder comprises a cylinder disposed and overlapped to later part of the first holder.

16. The light source adjusting module of claim 12, wherein the module further comprises a reflecting plate disposed along the optical path of a light beam entering the first optical element, and the reflecting plate has an opening that exposes at least a portion of the incident surface of the first optical element so that only the light passing through the opening enters the first optical element.

17. The light source adjusting module of claim 12, wherein the module further comprises a sleeve-adjusting member contacted to the sleeve for directly rotating the sleeve.

18. The light source adjusting module of claim 12, wherein the first optical element comprises a rod integrator.

19. The light source adjusting module of claim 12, wherein the second optical element comprises at least one lens.

20. The light source adjusting module of claim 17, wherein the module further comprises a first sleeve ring disposed over the sleeve and the first sleeve ring has a third groove such that the sleeve can be rotated by moving the sleeve-adjusting member within the third groove.

21. A light source adjusting module, for processing a light beam from a light source, comprising:
a sleeve;
a first optical element disposed inside the sleeve having an incident surface and an output surface, wherein a light beam enters the first optical element through the incident surface and emerges from the output surface of the first optical element;
a second optical element disposed on an optical path of the light beam behind the first optical element;
a first sleeve ring disposed over the sleeve g having a third groove; and
a sleeve-adjusting member contacted to the sleeve through the third groove so that the sleeve can be moved relative to the first and second optical element by moving the sleeve-adjusting member within the third groove.

22. The light source adjusting module of claim 21, wherein the module further comprises a reflecting plate disposed along the optical path of a light beam entering the first optical element, and the reflecting plate has an opening that exposes at least a portion of the incident surface of the first optical element so that only the light passing through the opening enters the first optical element.

23. The light source adjusting module of claim 21, wherein the surface of the sleeve having a first groove and the module further comprises:
a first holder disposed inside the sleeve for carrying the first optical element; and
a first adjusting member disposed on the sleeve, wherein the adjusting member passes through the first groove and connects to the first holder so that the first holder can be moved relative to the sleeve by moving the first adjusting member within the first groove.

24. The light source adjusting module of claim 23, wherein the first holder can be moved horizontally inside the sleeve by moving the first adjusting member within the first groove.

25. The light source adjusting module of claim 23, wherein the first holder can be rotated relative to the sleeve by moving the first adjusting member within the first groove.

26. The light source adjusting module of claim 25, wherein the module further comprises:
an elastic element, disposed within the axial gap on the outer surface of the first holder; and
a second sleeve ring, disposed over the first holder and contacted to the sleeve for stopping the elastic element from forcing the first holder away from the sleeve.

27. The light source adjusting module of claim 21, wherein the first optical element comprises a rod integrator.

28. The light source adjusting module of claim 21, wherein the second optical element comprises at least one lens.

29. A light source adjusting module, for guiding a light beam from a light source, comprising:
a sleeve having a first and second grooves on its surface;
a first optical element having an incident surface and an output surface, wherein a light beam enters the first optical element through the incident surface and emerges from the output surface of the first optical element;
a second optical element disposed on an optical path of the light beam behind the first optical element;
a first adjusting member contacted to the first optical element through said first groove of the sleeve so that the first optical element is moved relative to the sleeve by moving the first adjusting member;
a second holder disposed inside the sleeve for carrying the second optical element;
a second adjusting member mounted to the second holder through second groove of the sleeve so that the second holder and the second optical element are moved relative to the sleeve by moving the second adjusting member; and
a sleeve-adjusting member contacted to the sleeve for directly moving the sleeve.

30. The light source adjusting module of claim 29, wherein the second holder can be moved horizontally inside the sleeve by moving the second adjusting member within the second groove.

31. The light source adjusting module of claim 29, wherein the second holder comprises a cylinder disposed and overlapped to later part of the first holder.

32. The light source adjusting module of claim 29, wherein the module further comprises a reflecting plate disposed at one end of the first holder over the incident surface of the first optical element, and the reflecting plate has an opening that exposes at least a portion of the incident surface of the first optical element so that any interfering background light is filtered off.

33. The light source adjusting module of claim 29, wherein the first holder can be moved horizontally inside the sleeve by moving the first adjusting member within the first groove.

34. The light source adjusting module of claim 29, wherein the first holder can be rotated relative to the sleeve by moving the first adjusting member within the first groove.

35. The light source adjusting module of claim 29, wherein the module further comprises:
an elastic element disposed over the outer surface of the first holder; and
a second sleeve ring disposed over the first holder and the elastic element mounted to the sleeve for stopping the elastic element from forcing the first holder away from the sleeve.

36. The light source adjusting module of claim 29, wherein the first optical element comprises a rod integrator.

37. The light source adjusting module of claim 29, wherein the second optical element comprises at least one lens.
